(19) United States
(12) Patent Application Publication
(10) Pub. No.: US 2014/0131144 A1
(43) Pub. Date: May 15, 2014

(54) SPRING LOADED SMART DOCK BUMPER

(71) Applicants: Peter Anderson Bynoe, Conyers, GA (US); Andrea A. White, Conyers, GA (US)

(72) Inventors: Peter Anderson Bynoe, Conyers, GA (US); Andrea A. White, Conyers, GA (US)

(21) Appl. No.: 13/678,509

(22) Filed: Nov. 15, 2012

(51) Int. Cl. B65G 69/28

(52) U.S. Cl. CPC B65G 69/2876
USPC 188/1.11 E; 188/1.11 R

(57) ABSTRACT

A spring loaded smart loading dock bumper has an indicator light that illuminates when the bumper is pressed. As a trailer backs up to a loading dock, for example, drivers often have a hard time judging when their trailer will be close enough to the loading dock, often resulting in bumping into the loading dock, damaging the dock and/or the trailer. With the spring loaded smart loading dock bumper, the backing trailer can bump into the dock bumper, causing the bumper to resilient move to depress a switch, illuminating a light that can be easily seen by the driver.

### BACKGROUND OF THE INVENTION

The present invention relates to bumpers and, more particularly, to a spring loaded smart dock bumper.

When tractor trailers back into loading docks, or other similar locations, it can be difficult to determine when they are close enough without physically running into the loading dock. This continual backing the truck into the loading dock can cause damage to both the truck and the loading dock itself.

As can be seen, there is a need for methods and devices to help prevent a trailer from hitting a building when backing up toward the building, for example, when backing into a loading dock of a building.

### SUMMARY OF THE INVENTION

In one aspect of the present invention, a bumper assembly comprises a bracket; a bumper positioned in front of the bracket and attached to a slot in the bracket, the slot permitting the bumper to move toward and away from the bracket; a spring resiliently pressing the bumper away from the bracket; a switch disposed between the bumper and the bracket, the switch being engaged with the bumper is moved toward the bracket; and an indicator operable to create an alert when the switch is engaged.

In another aspect of the present invention, a bumper assembly comprises a bracket; a bumper positioned in front of the bracket and attached to a slot in the bracket, the slot permitting the bumper to move toward and away from the bracket; a spring resiliently pressing the bumper away from the bracket; a switch disposed between the bumper and the bracket, the switch being engaged with the bumper is moved toward the bracket; a light disposed away from the bracket, the light operable to illuminate when the switch is engaged; and a ball roller disposed on a top end and a bottom end of the bumper.

In a further aspect of the present invention, a method for preventing damage to a loading dock comprises disposing one or more bumper assemblies in front of the loading dock, the bumper assembly including a bracket, a bumper positioned in front of the bracket and attached to a slot in the bracket, the slot permitting the bumper to move toward and away from the bracket, a spring resiliently pressing the bumper away from the bracket, and a switch disposed between the bumper and the bracket, the switch being engaged with the bumper is moved toward the bracket; and illuminating an indicator light when the switch is engaged due to a trailer backing toward the loading dock.

These and other features, aspects and advantages of the present invention will become better understood with reference to the following drawings, description and claims.

### BRIEF DESCRIPTION OF THE DRAWINGS

FIG. 1 is a perspective view of a spring loaded smart dock bumper, in use, according to an exemplary embodiment of the present invention;

FIG. 2 is a perspective view of the spring loaded smart dock bumper of FIG. 1;

FIG. 3 is an exploded perspective view of the spring loaded smart dock bumper of FIG. 1;

FIG. 4 is a side view of the spring loaded smart dock bumper of FIG. 1, showing a trailer backing toward the bumper; and

FIG. 5 is a side view of the spring loaded smart dock bumper of FIG. 1, showing illumination of a light when the trailer presses into the bumper.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a spring loaded smart loading dock bumper that has an indicator light that illuminates when the bumper is pressed. As a trailer backs up to a loading dock, for example, drivers often have a hard time judging when their trailer will be close enough to the loading dock, often resulting in bumping into the loading dock, damaging the dock and/or the trailer. With the spring loaded smart loading dock bumper, the backing trailer can bump into the dock bumper, causing the bumper to resilient move to depress a switch, illuminating a light that can be easily seen by the driver.

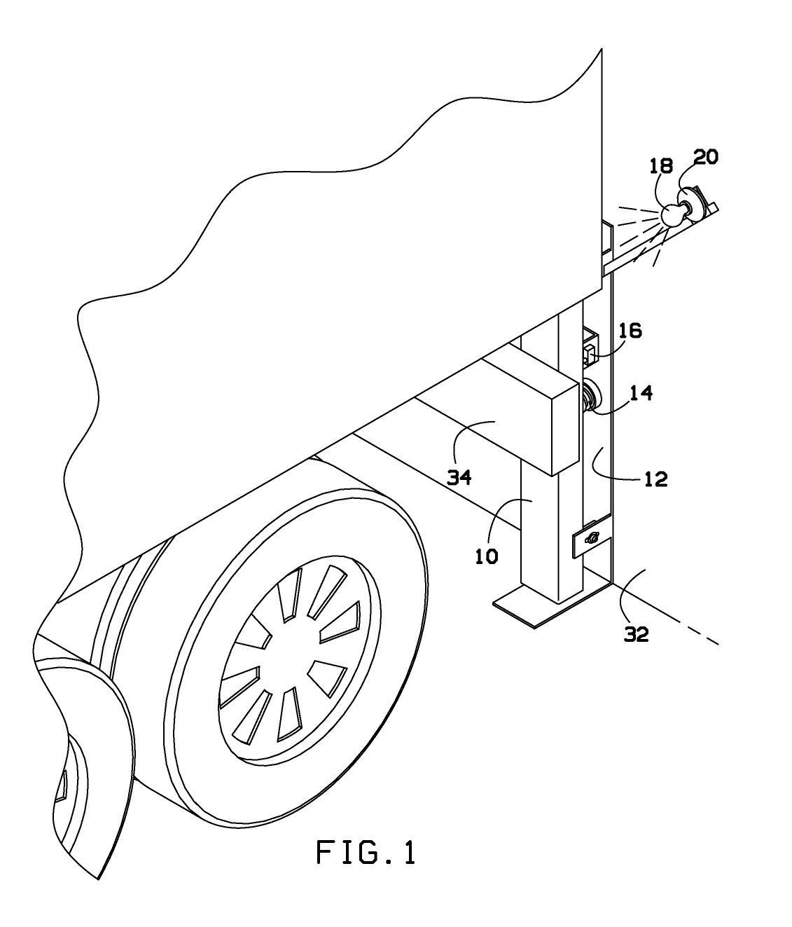

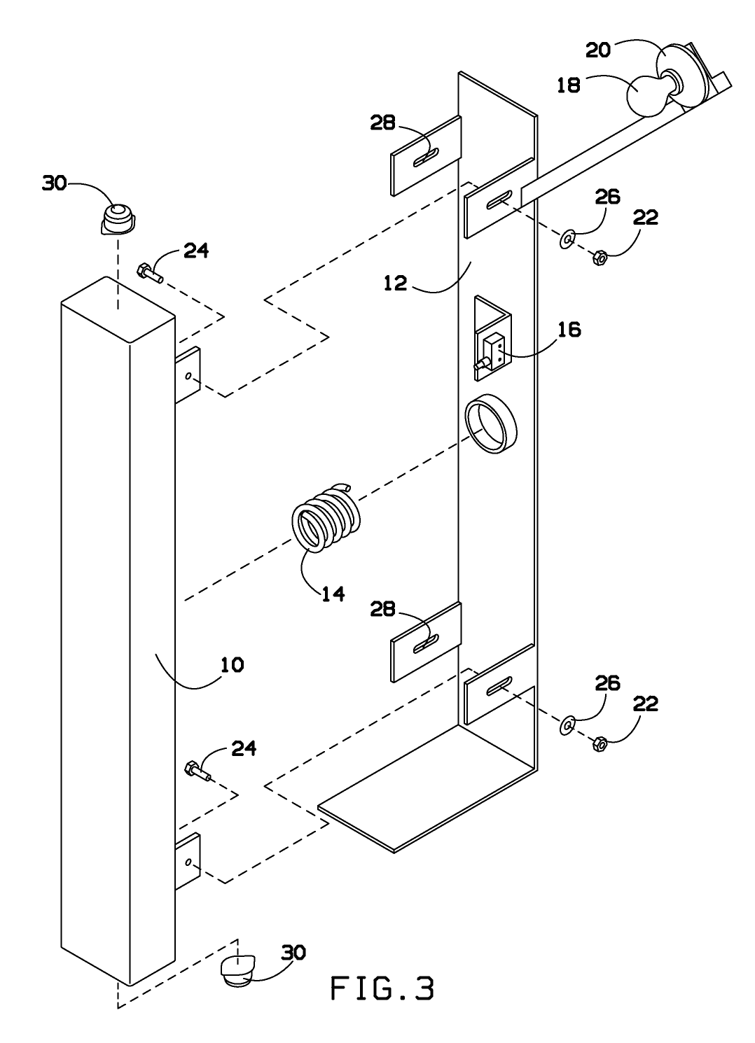

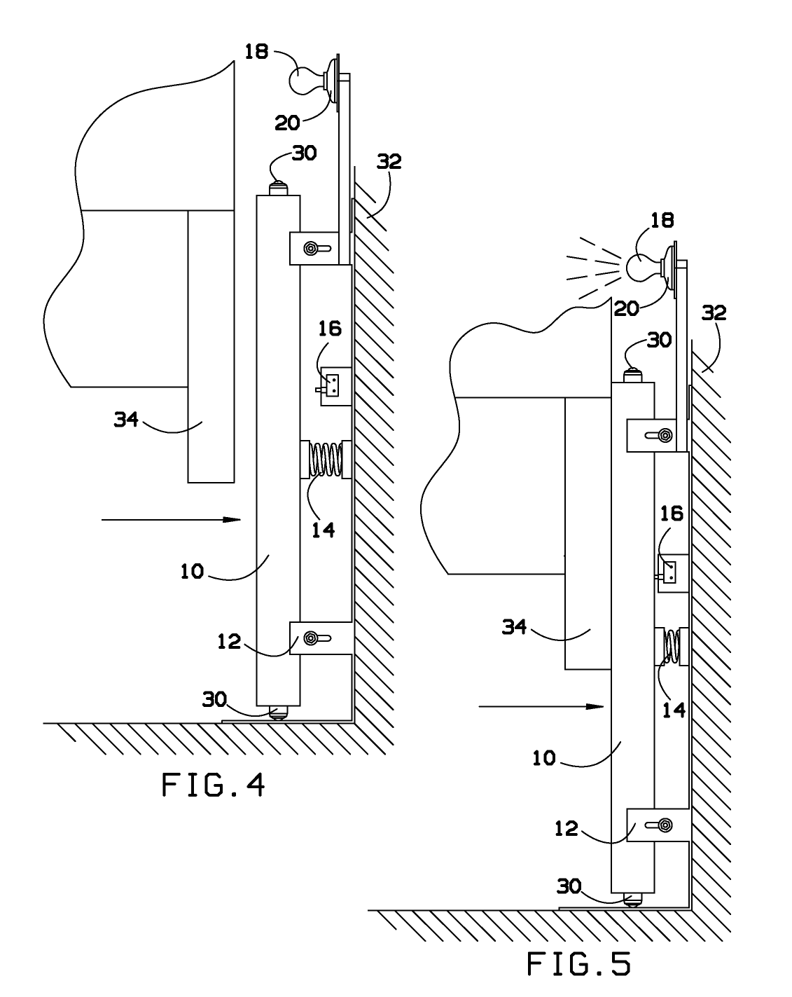

Referring now to FIGS. 1 through 5, a bumper 10 can be mounted to a bracket 12 with at least one spring 14 resiliently pushing the bumper 10 away from the bracket 12. The bumper 10 can attach to the bumper 12 with bolts 12, washers 26 and nuts 22 passing into a slot 28 in the bracket 12, the slot 28 defining the direction and length of movement of the bumper 10 toward the bracket 12 against the force of the spring 14.

The bumper 10 can be made of a strong material, such as steel. In some embodiments, the bumper 10 can be made with a hollow interior that may be filled with a material, such as sand.

A plunger switch 16 can be disposed between the bumper 10 and the bracket 12 such that when the bumper 10 is pushed toward the bracket 12, the plunger switch 16 is engaged, causing an indicator, such as a light 18 disposed in a light socket 20 to generate an alert, such as to illuminate. The alert can include other forms of alert, such as a sound, a flash of light, or the like. The light 18 can be positioned away from the bracket 12 such that a driver backing a trailer 34 toward a loading dock 32, having the bumper 10 in place, can see the light 18 from the cab of their truck. The light socket 20 can be attached to the bracket 12, as shown in the Figures, or may be mounted disconnected from the bracket 12, but electrically connected with the plunger switch 16.

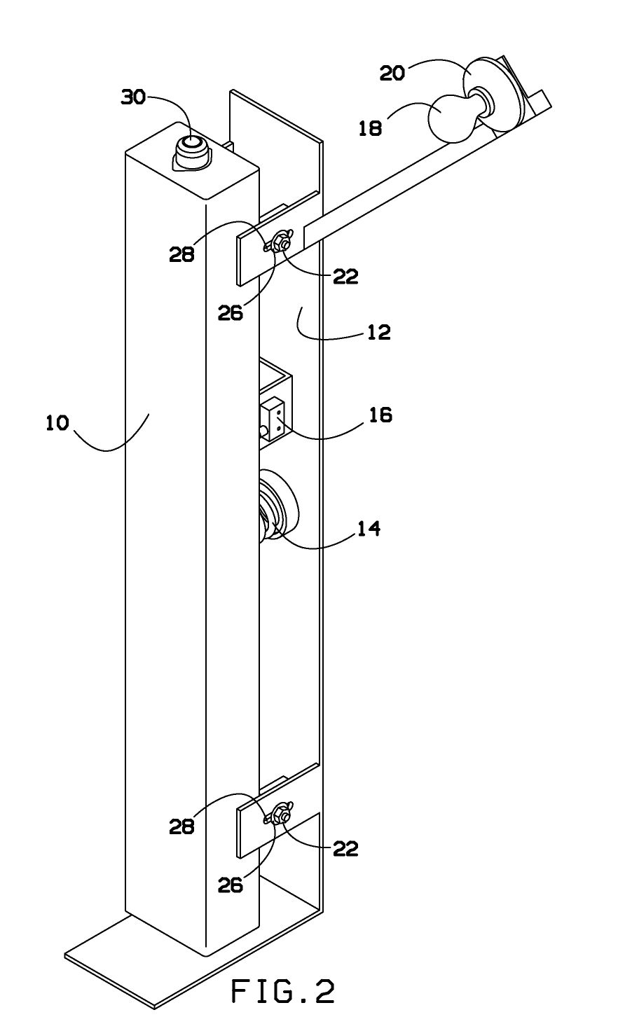

A ball roller 30 can be disposed on an upper end and a lower end of the bumper 10. The ball roller 30 on the upper end can allow items to roll over the bumper 10. The ball roller 30 on the lower end can support the bumper 10 and allow the bumper 10 to move smoothly along a surface when depressed by, for example, a truck trailer. In some embodiment, the bracket 12 can be L-shaped, where the bottom of the L-shape can support the bumper 10, as shown in FIG. 2, for example.

The spring loaded smart dock bumper can be disposed at the loading dock 32 to prevent the trailer 34 from backing directly into the loading dock 32, but, instead, hitting the bumper 10 which presses against the spring 14 to engage the plunger switch 16, illuminating the light 18. When the driver sees the light 18 turn on, they know they are to stop before subjecting the loading dock 32 and/or the trailer 34 to the full force of the backing truck.

The length of the slot 28 can define the amount of movement the bumper 10 may be able to move before it is fully engaged against the bracket 12. This length can vary with application. Similarly, the position of the plunger switch 16 can define when the light 18 illuminates. In some embodiments, the plunger switch 16 can be disposed directly behind the bumper 10 such that only a minimal movement (such as one inch or less) can activate the switch 16 and illuminate the light 18.

It should be understood, of course, that the foregoing relates to exemplary embodiments of the invention and that modifications may be made without departing from the spirit and scope of the invention as set forth in the following claims.

What is claimed is:

1. A bumper assembly comprising:
a bracket;
a bumper positioned in front of the bracket and attached to a slot in the bracket, the slot permitting the bumper to move toward and away from the bracket;
a spring resiliently pressing the bumper away from the bracket;
a switch disposed between the bumper and the bracket, the switch being engaged with the bumper is moved toward the bracket; and
an indicator operable to create an alert when the switch is engaged.

2. The bumper assembly of claim 1, wherein the indicator is a light.

3. The bumper assembly of claim 2, wherein the light is disposed away from the bracket.

4. The bumper assembly of claim 1, further comprising a ball roller disposed on a top end and a bottom end of the bumper.

5. The bumper assembly of claim 2, wherein the light is disposed in a light socket mounted in a position viewable by a driver backing a trailer toward the bumper assembly.

6. A bumper assembly comprising:
a bracket;
a bumper positioned in front of the bracket and attached to a slot in the bracket, the slot permitting the bumper to move toward and away from the bracket;
a spring resiliently pressing the bumper away from the bracket;
a switch disposed between the bumper and the bracket, the switch being engaged with the bumper is moved toward the bracket;
a light disposed away from the bracket, the light operable to illuminate when the switch is engaged; and
a ball roller disposed on a top end and a bottom end of the bumper.

7. The bumper assembly of claim 6, wherein the light is disposed in a light socket mounted in a position viewable by a driver backing a trailer toward the bumper assembly.

8. A method for preventing damage to a loading dock, the method comprising:
disposing one or more bumper assemblies in front of the loading dock, the bumper assembly including a bracket, a bumper positioned in front of the bracket and attached to a slot in the bracket, the slot permitting the bumper to move toward and away from the bracket, a spring resiliently pressing the bumper away from the bracket, and a switch disposed between the bumper and the bracket, the switch being engaged with the bumper is moved toward the bracket; and
illuminating an indicator light when the switch is engaged due to a trailer backing toward the loading dock.

9. The method of claim 8, further comprising moving the bumper along one or more ball rollers disposed on a top end and a bottom end of the bumper.

10. The method of claim 8, wherein the light is disposed in a light socket mounted in a position viewable by a driver backing the trailer toward the bumper assembly.
